(19) United States
(12) Patent Application Publication
(10) Pub. No.: US 2007/0243778 A1
(43) Pub. Date: Oct. 18, 2007

(54) FUEL SYSTEM FOR OUTBOARD MOTOR

(75) Inventors: Hidemasa Kamito, Shizuoka-ken (JP); Hiroyuki Tsunekawa, Shizuoka-ken (JP); Shintaro Kawaguchi, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MARINE KABUSHIKI KAISHA, Hamamatsu-shi (JP)

(21) Appl. No.: 11/617,682

(22) Filed: Dec. 28, 2006

(30) Foreign Application Priority Data
Apr. 18, 2006 (JP) 2006-114073

(51) Int. Cl. F02M 37/20; F02B 61/04

(52) U.S. Cl. 440/88 F

(57) ABSTRACT

A boat has an outboard motor that is mounted to a hull and has a fuel system. The outboard motor has a cowling housing an engine. The fuel system includes an insulator that covers at least a portion of a fuel filter. The insulator provides a physical and thermal barrier to seawater and engine heat that may otherwise cause vaporization of the fuel. The insulator may include one or more insulating pieces.

### RELATED APPLICATIONS

The present application is based on and claims priority under 35 U.S.C. §119(a)-(d) to Japanese Patent Application No. 2006-114073, filed on Apr. 18, 2006, the entire contents of which is hereby expressly incorporated by reference herein.

### BACKGROUND OF THE INVENTION

1. Field of the Invention

The present invention relates to fuel systems for a boat having an outboard motor.

2. Description of the Related Art

Known outboard motors have a series of fuel pumps for supplying fuel between the fuel tank and the engine. For example, a low pressure primary pump sends fuel from the hull and through a fuel filter to a vapor separator in the outboard motor. A high pressure secondary pump sends the fuel accumulating at the vapor separator to the engine's filet injectors (see Patent Document JP-A-2002-161813). However, the temperature in a cowling of the outboard motor may increase due to the heat from the engine. The heat from the engine may then heat the fuel filter and the fuel conduit which may vaporize the fuel within.

### SUMMARY OF THE INVENTION

A need exists for a fuel system that reduces the likelihood of vaporization occurring in the fuel system in order to increase engine reliability.

An aspect of the invention involves an outboard motor for a boat that includes a cowling defining an engine compartment and houses an engine. The outboard motor includes a fuel delivery conduit and fuel filter disposed in the engine compartment. The fuel filter is disposed between the ends of the fuel delivery conduit. At least a portion of the fuel filter is covered by a heat insulator.

Another aspect of the invention involves a boat that includes a hull and an outboard motor mounted to the hull. The boat includes a cowling that houses an engine. The boat further includes a fuel filter located within the cowling and an insulator disposed around at least a portion of the fuel filter.

An addition aspect of the invention involves a fuel system for an outboard motor having an engine. The fuel system includes a fuel filter, which has a filter media, disposed inside the outboard motor and an insulator disposed around at least a portion of the fuel filter.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely an example and are not intended to limit the invention. The following is a brief description of the drawings.

FIG. 1 is a side view of an outboard motor configured in accordance with a preferred embodiment of the present invention, illustrated as attached to a transom of a boat with some internal components shown in phantom lines.

FIG. 2 is an enlarged side sectional view of an upper portion of the outboard motor from FIG. 1 showing and engine and an associated fuel supply system.

FIG. 3 is a top plan view of the outboard motor from FIG. 2 showing the V-shape arrangement of the engine of the outboard motor.

FIG. 4 is a front view of the outboard motor from FIG. 2.

FIG. 5 is an enlarged partial front side view of the outboard motor of FIG. 4 including an insulated fuel filter and associated fuel conduits.

### DETAILED DESCRIPTION OF THE PREFERRED EMBODIMENTS

The following detailed description is now directed to certain specific embodiments of the invention. In this description, reference is made to the drawing wherein like parts are designated with like numerals throughout the description and the drawing.

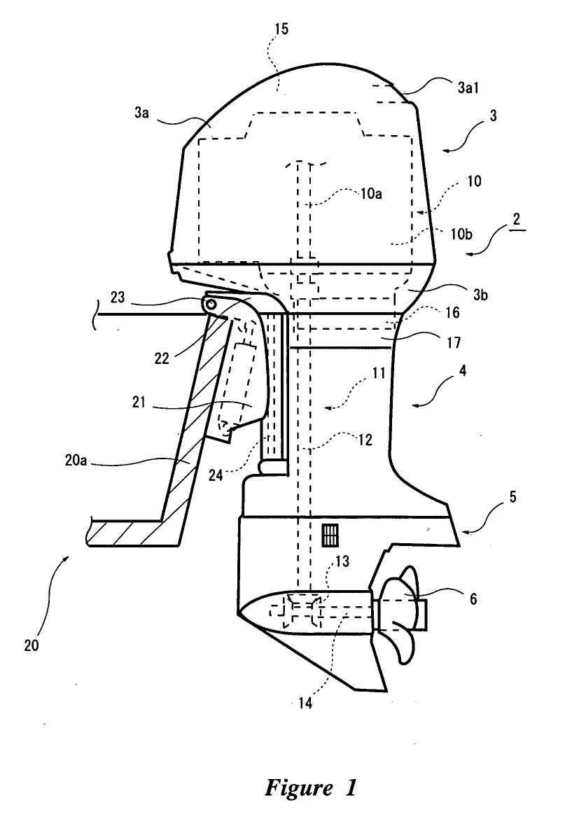

FIG. 1 is a schematic view of a boat having a fuel system configured in accordance with a preferred embodiment of the present invention. The boat includes a hull 20 and an outboard motor 1. The outboard motor 1 is mounted to the hull 20 by a bracket 21. The clamping bracket 21 is fixed to a transom board 20a of the hull 20. A tilt shaft 23 couples a swivel bracket 22 with the clamping bracket 21 so that the clamping bracket 21 supports the swivel bracket 22 for pivotal movement about an axis of the tilt shaft 23.

A front side of the outboard motor 1 is positioned on a hull side of the boat, while a rear side of the outboard motor 1 is positioned on the opposite side of the hull 20. The horizontal direction is generally the direction of travel for the boat. The vertical direction is generally perpendicular to the horizontal direction.

The outboard motor 1 includes a propulsion unit 2. The swivel bracket 22 carries the propulsion unit 2 for pivotal movement about an axis of a steering shaft 24. The housing of the propulsion unit 2 is formed by a cowling 3, an upper casing 4, and a lower casing 5. The cowling 3 encloses an engine 10. The engine 10 includes a crankshaft 10a.

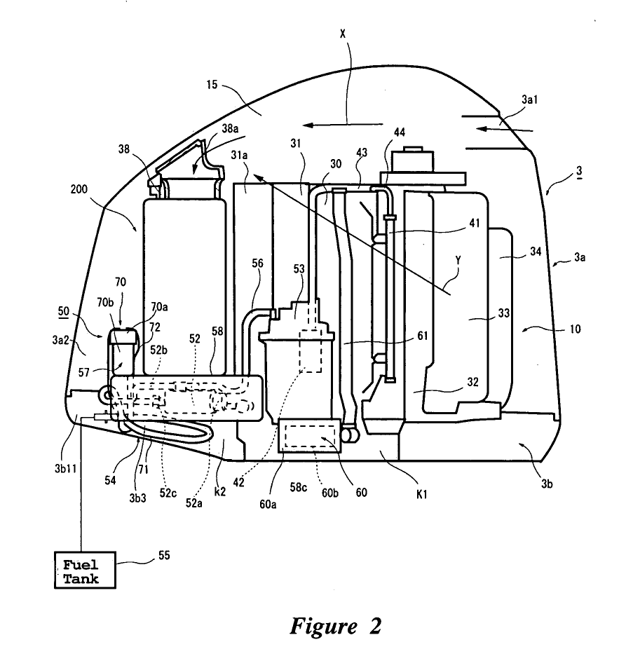

FIG. 2 is a schematic view of an upper portion of the outboard motor 1 from FIG. 1 showing the fuel system. As most clearly shown in FIG. 2, the crankshaft 10a is positioned between the hull 20 and the cylinders 10b of the engine 10. A power transmission mechanism 11 and exhaust passages (not shown) extend from the engine 10 and through the upper casing 4 and the lower casing 5. The power transmission mechanism 11 includes a driveshaft 12, a mode shifting mechanism 13 and a propeller shaft 14. The power from the engine 10 rotates a propeller 6 through the power transmission mechanism 11.

The cowling 3 defines an engine compartment 15 and includes a top cowling member 3a and a bottom cowling member 3b. The top cowling member 3a includes an air intake opening 3a1. Air entering the intake opening 3a1 is routed to the engine 10 and engine compartment 15. An exhaust guide 16 is disposed at a top end of the upper casing 4. The engine 10 is fixed to a top surface of the exhaust guide 16.

In the illustrated embodiment, an apron 17 is attached to a top portion of the upper casing 4 and to the exhaust guide 16. The top cowling member 3a covers the engine 10 and preferably is removably attached to the bottom cowling member 3b. The bottom cowling member 3b is fixed to the exhaust guide 16.

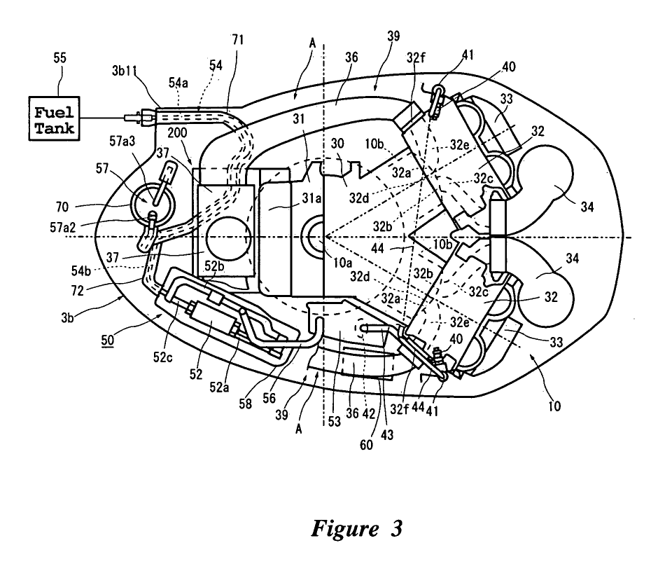

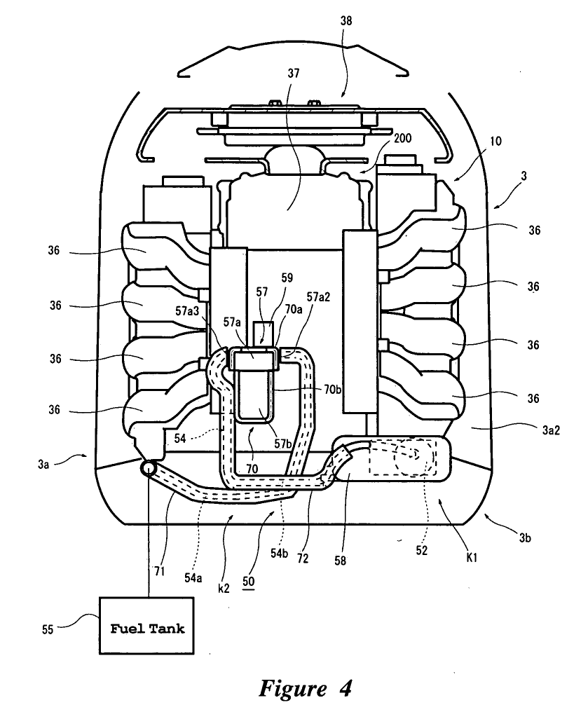

FIG. 3 is a top plan view of the outboard motor 1 from FIG. 2 showing the V-shape arrangement of the engine 10 of the outboard motor 1. FIG. 4 is a front view of the outboard motor 1 from FIG. 2. As shown in FIGS. 2 through 4, the exemplary engine 10 is a four stroke, V-type, eight-cylinder engine. Of course the invention is not limited to a specific engine type or arrangement of cylinders.

The outboard motor 1 is mounted to the transom board 20a of the boat 20 so as to be movable between a running position, in which the crankshaft 10a extends substantially in a vertical direction, and a tilt-up position, in which the propeller 6 is raised out of the water.

A crankcase 31 is attached to a front mating surface of a cylinder block 30 of the engine 10. A crankcase cover 31a is attached to the crankcase 31. Cylinder heads 32 are attached to the rear mating surfaces of the cylinder block 30. A head cover 33 covers an opening to each cylinder head 32. The head covers 33 and the cylinder heads 32 are directed generally in a rearward direction away from the hull 20.

The cylinder block 30 includes right and left cylinders 10b. The cylinders 10b are arranged in a V-shape and extend toward the crankshaft 10a. Each cylinder head 32 has one or more intake valve openings 32a and exhaust valve openings 32b for the respective cylinder. The respective intake valve openings 32a and the exhaust valve openings 32b communicate with combustion chambers 32d defined in the V-shaped banks.

Exhaust gas exits the exhaust valve openings 32b and is routed to a space defined between the V-shaped banks through respective exhaust ports 32c. The exhaust gases from each bank are merged into individual exhaust manifolds 34 located in the space. Exhaust gases are discharged through the exhaust manifolds 34 and to the body of water below the engine. The intake manifolds 36 have been omitted from FIG. 2.

The intake valve openings 32a for the respective banks are in flow communication with intake ports 32e passing through the respective cylinder heads 32. An intake manifold 36 connects to each outside connecting opening 32f of the respective intake port 32e. The intake manifold 36 may include a bent portion 39 that is in flow communication with the intake port 32e and a surge tank 200. As is shown most clearly in FIG. 3, intake passages “A” extend in a forward direction.

The illustrated embodiment includes a throttle body 37 that contains a throttle valve (not shown). The throttle body 37 connects to the surge tank 200. An intake silencer 38 is connected to an upstream portion of the throttle body 37. Of course the invention is not limited to a specific type of fuel delivery system and may be employed with fuel systems that include a carburetor or another type of fuel injection (e.g. direct injection).

Fuel injectors 40 are located in the intake ports 32e of the cylinder heads 32 in the respective cylinders. An injection nozzle of each fuel injector is directed toward the respective combustion chamber 32d. Tubular fuel delivery rails 41 are disposed in such a manner that each rail 41 is oriented toward the crankshaft 10a and is positioned outside of the respective cylinder head 32.

A fuel supply device 50 supplies fuel to the fuel injectors 40. In the illustrated embodiment, the fuel supply device 50 includes a fuel filter 57, a low pressure primary pump 52 built in a sealed container 58, and a vapor separator 53.

The low pressure primary pump 52 delivers fuel from a fuel tank 55 to the vapor separator 53. The pump 52 creates positive pressure in the fuel lines, pushing the fuel to the engine. The pump 52 includes a housing having an inlet and an outlet. For an electric fuel pump, an electric motor and impeller may be located within the housing. The electric motor drives the impeller which causes fuel to enter the inlet and exit via the outlet.

The fuel passes through a low pressure fuel delivery conduit 54a, a fuel filter 57, and a low pressure fuel delivery conduit 54b before reaching the vapor separator 53. A gas-liquid separation chamber is formed in the vapor separator 53. The gas-liquid separation chamber separates oil mist from blowby gas to inhibit the oil mist from being discharged into the atmosphere.

Surplus fuel is expelled from a discharge port 52a of the primary pump 52 and returned to a suction port 52c of the primary pump 52 through a return passage 52b.

The primary pump 52 delivers the fuel through a fuel delivery conduit 56 to a high pressure secondary pump 42. The fuel pressurized by this secondary pump 42 is delivered to the ends of the right and left fuel delivery rails 41 through a high pressure fuel delivery conduit 43 and a right-left bifurcated hose 44. The fuel is injected into each combustion chamber 32d during a period in which the injection nozzle of the respective fuel injector 40 is opened.

A canister 60 is attached securely to the vapor separator 53. The canister 60 includes a case 60a. The case 60a is connected to the vapor separator 53 and is filled with an absorbent 60b such as, for example, active carbon. Vapors in the vapor separator 53 enter the canister 60 and are absorbed by the absorbent 60b. The air from which the fuel is separated by absorption is discharged through a discharge pipe 61 to the interior of the cowling 3.

In the illustrated embodiment, the canister 60 is disposed below the lower most portion of the intake manifold 36 and on the left side. As shown in FIGS. 2 and 4, the vapor separator 53 and the canister 60 are disposed in a dead space K1 formed by the V-shaped banks on the left side of the cylinder block 30. The area occupied by the fuel system components is reduced by positioning the canister 60 below the intake manifold 36. This arrangement further allows the width of the top cowling member 3a to be reduced.

As best seen in FIG. 3, the fuel filter 57 may be positioned on the opposite side of the cylinder heads 32 with respect to the crankshaft 10a of the engine 10 within the cowling 3. That is, the fuel filter 57 is disposed on the side of the surge tank 200 closer to the hull 20. The fuel filter 57 is preferably positioned lower than the air intake opening 3a1 in the top cowling member 3a. Preferably, the fuel filter 57 is positioned adjacent to a bottom opening 3a2 in the top cowling member 3a.

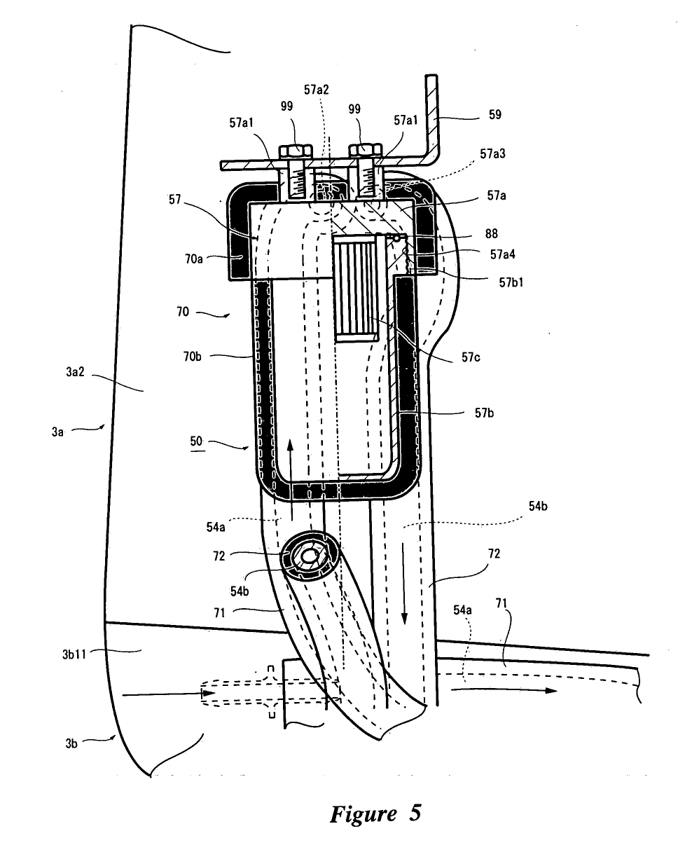

FIG. 5 is an enlarged partial front side view of the outboard motor 1 of FIG. 4 including an insulated fuel filter 57 and associated fuel conduit. The fuel filter 57 includes a body section 57a, a cap section 57b and a filter section 57c. Mount bosses 57a1 are formed on the body section 57a. The body section 57a is preferably fastened to a bracket 59 by fastening bolts 99 into the mount bosses 57a1. The bracket 59 is fixed to the side of the surge tank 200 closer to the hull. A female screw is formed in a recessed portion 57a4 of the body section 57a, while a male screw is formed on an attaching portion 57b1 of the cap section 57b. The cap section 57b thus is detachably fixed to the body section 57a by the screwed structure. A mating surface of the recessed portion 57a4 of the body section 57a and the attaching portion 57b1 of the cap section 57b is sealed with an O-ring 88. A filter section 57c is disposed in the recessed portion 57a4 of the body section 57a so as to allow attachment and detachment from below. The body section 57a has an inlet port 57a2 and an outlet port 57a3. The low pressure fuel delivery conduit 54a is connected to the inlet port 57a2, while the low pressure fuel delivery conduit 54b is connected to the outlet port 57a3.

An insulating section 70 of heat insulating material preferably covers the fuel filter 57. For example, the insulating section 70 may be made of foam rubber or the like. The insulating section 70 preferably has a shape similar to the outer shape of the fuel filter 57. The insulating section 70 may be formed from one or more pieces. For example, a first piece 70a may cover the body section 57a while a second piece 70b covers the cap section 57b. The first piece 70a covering the body section 57a may have a shape that matches the outer shape of the body section 57a, while the second piece 70b that covers the cap section 57b has a shape that matches the outer surface of the cap section 57b.

The heat insulator 70 covering the fuel filter 57 inhibits the fuel filter 57 from being heated by the heat of the engine 10 and inhibits vaporization of the fuel. By insulating the fuel filter 57, the heat from the engine 10 is inhibited from vaporizing fuel in the fuel filter 57 even after stopping the engine 10. Preferably the inside surface of the heat insulating section 70 matches the outer surface of the fuel filter 57 to minimize gaps between the two surfaces which improves the heat insulation efficiency. In addition, the shape of the heat insulator 70 preferably conforms to that of the fuel filter 57 so as prevent deformation of the fuel filter 57. Furthermore, because the heat insulator 70 functions as a protective member, the fuel filter 57 is protected from damage due to an external force.

The piece 70a covering the body section 57a and the piece 70b covering the cap section 57b can be separately and easily attached to the associated sections 57a, 57b of the fuel filter 57. Also, when the cap section 57b is removed for cleaning from the body section 57b or when the filter section 57c is replaced, the insulating section 70 is easily attached to the fuel filter 57. Thus, assembly and maintenance work is easier.

Because the fuel filter 57 is positioned on the side of the engine 10 closer to the hull in the cowling 3, a worker, a user, a mechanic or the like can easily attach the fuel filter 57 by removing the top cowling member 3a. The assembling work can be done easily, and the replacement or maintenance work on the filter 57 is also easy to perform. Preferably, the fuel filter 57 is spaced apart from the exhaust manifolds 34 to reduce any heating of the fuel filter 57 by the engine 10.

As most clearly shown in FIG. 2, air “X” flows from the air intake opening 3a1 toward the intake air silencer 38. Air heated by the engine 10 “Y” also flows toward the air intake opening 3a1. The fuel filter 57 is preferably positioned lower than the air intake opening 3a1 of the top cowling member 3a through which the air enters the engine 10. Although the air “Y” heated by the engine 10 also flows in the engine compartment 15 of the cowling 3, the fuel filter 57 is located out of the path of air “Y.” Therefore, the fuel filter 57 can be further inhibited from being heated by the engine 10.

A one-piece heat insulator may cover the body section 57a and the cap section 57b of the fuel filter 57. The insulators disclosed herein can be employed with fuel filters of various structures in addition to the exemplary fuel filter 57 disclosed herein.

Additional heat insulating sections 71, 72 may cover at least a portion of the fuel delivery conduit 54 connected to the fuel filter 57, i.e., the fuel delivery conduits 54a, 54b. The fuel delivery conduit 54a extends through a right front portion 3b11 of the bottom cowling member 3b to enter the interior thereof. The fuel delivery conduit 54a may have a bend in the vicinity of the surge tank 200 and extend below the surge tank 200. The fuel delivery conduit 54a extends upward from below the fuel filter 57 and connects to the inlet port 57a2 on the left side of the fuel filter 57. The fuel delivery conduit 54b is connected to the outlet port 57a3 on the right side of the fuel filter 57 and extends downward along the fuel filter 57. The fuel delivery conduit 54b may further extend below the fuel filter 57 and connect to the primary pump 52 in the sealed container 58.

As shown in FIGS. 2 and 4, the low pressure fuel delivery conduit 54a and the low pressure fuel delivery conduit 54b are located within the dead space K2 around the fuel filter 57 and below the surge tank 200. The low pressure fuel delivery conduit 54a and the low pressure fuel delivery conduit 54b are preferably covered with the insulating sections 71, 72, respectively. Thus, the insulated fuel conduit 54 inhibits the fuel from being heated. Preferably the portion of the fuel delivery conduit 54 connected to the low pressure primary pump 52 is covered with the insulating sections 71, 72. The fuel delivery conduits 54a, 54b are more susceptible to generating vapors if heated because the fuel passing there through is at a negative pressure due to the low pressure primary pump 52. Heating of the fuel can be inhibited due to the fuel delivery conduits 54a, 54b being insulated by insulating sections 71, 72.

The insulating sections 70, 71, 72 may be made of foam rubber or the like. Even if water enters the cowling 3, the heat insulation and the durability of the insulators 70, 71, 72 can be maintained. In addition, the insulators 70, 71, 72 are inexpensive, and easy to assemble and attach.

This invention provides a simple structure that can be applied to an outboard motor having a fuel filter, and can insulate and shield the fuel filter to improve engine reliability.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof.

In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims,

What is claimed is:

1. An outboard motor for a boat, comprising:
a cowling defining an engine compartment;
an engine disposed in the engine compartment;
a fuel delivery conduit being disposed in the engine compartment and supplying fuel to the engine;
a fuel filter disposed between the ends of the fuel delivery conduit; and
a heat insulator covering at least a portion of the fuel filter.

2. The outboard motor according to claim 1, wherein the heat insulator comprises multiple pieces.

3. The outboard motor according to claim 1, wherein a shape of an inside surface of the heat insulator generally matches a shape of an outside surface of the fuel filter.

4. The outboard motor according to claim 1, wherein the fuel filter is positioned on an opposite side of a cylinder head relative to a crankshaft of the engine.

5. The outboard motor according to claim 1, wherein at least a portion of the fuel filter is positioned in front of a crankcase of the engine.

6. The outboard motor according to claim 1, wherein the fuel filter is positioned lower than an intake opening through which air is introduced into the engine via an interior of the cowling.

7. The outboard motor according to claim 1, wherein at least a portion of the fuel delivery conduit connected to the fuel filter is covered with a second heat insulator.

8. The outboard motor according to claim 1 further comprising a fuel pump and a vapor separator, the fuel pump being configured to supply fuel to the vapor separator through the fuel filter.

9. The outboard motor according to claim 8, wherein the fuel pump is further configured to supply fuel accumulated in the vapor separator to a fuel injector in the engine, and wherein at least a portion of the fuel delivery conduit is covered with a second heat insulator.

10. The outboard motor according to claim 1, wherein the heat insulator is made of foam rubber.

11. An outboard motor comprising:
an outboard motor being configured to be mounted to a boat hull and having a cowling, the cowling housing an engine;
a fuel filter located within the cowling; and
an insulator disposed around at least a portion of the fuel filter.

12. The outboard motor according to claim 11, wherein the insulator comprises multiple pieces.

13. The outboard motor according to claim 11 further comprising an engine compartment, the fuel filter being disposed at the front of the engine compartment.

14. The outboard motor according to claim 11, wherein the fuel filter is positioned on an opposite side of a crankshaft of the engine from a cylinder head of the engine.

15. The outboard motor according to claim 11, wherein at least a portion of the fuel filter is positioned in front of a crankcase of the engine.

16. The outboard motor according to claim 11 further comprising:
a fuel pump that is fluidic communication with the fuel filter; and
a pressure regulator arranged in a fluid delivery conduit communicating with the fuel filter.

17. The outboard motor according to claim 16 further comprising a second insulator, at least a portion of the second insulator being disposed around at least a portion of the fluid delivery conduit.

18. A fuel system for an outboard motor having an engine, the fuel system comprising:
a fuel filter, which has a filter media, disposed inside the outboard motor; and
an insulator disposed around at least a portion of fuel filter.

19. The fuel system according to claim 18, wherein the heat insulator comprises multiple pieces.

20. The fuel system according to claim 18, wherein the heat insulator comprises a foam material.
